(19) United States
(12) Patent Application Publication
(10) Pub. No.: US 2018/0063377 A1
(43) Pub. Date: Mar. 1, 2018

(54) INFORMATION PROCESSING APPARATUS, IMAGE FORMING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Shigeru TANABE, Kanagawa (JP)

(73) Assignee: FUJI XEROX CO., LTD., Tokyo (JP)

(21) Appl. No.: 15/447,720

(22) Filed: Mar. 2, 2017

(30) Foreign Application Priority Data
Aug. 29, 2016 (JP) 2016-166467

(51) Int. Cl. H04N 1/44; H04N 1/00

(52) U.S. Cl. CPC H04N 1/4433; H04N 2201/0094; H04N 1/00413; H04N 1/00474

(57) ABSTRACT

An information processing apparatus includes an authenticating unit and a controller. The authenticating unit authenticates an operator. The controller performs control such that a setting item selected from plural setting items is not displayed for the operator authenticated by the authenticating unit. In the case where a set value for the setting item which is controlled by the controller so as not to be displayed is changed to a set value that is different from a set value registered for the authenticated operator, the controller performs control so as to display the setting item with the changed set value.

### CROSS-REFERENCE TO RELATED APPLICATIONS

This application is based on and claims priority under 35 USC 119 from Japanese Patent Application No. 2016-166467 filed Aug. 29, 2016.

### BACKGROUND

### Technical Field

The present invention relates to an information processing apparatus, an image forming apparatus, an information processing method, and a non-transitory computer readable medium.

### SUMMARY

According to an aspect of the present invention, there is provided an information processing apparatus including: an authenticating unit that authenticates an operator; and a controller that performs control such that a setting item selected from plural setting items is not displayed for the operator authenticated by the authenticating unit, in which in a case where a set value for the setting item which is controlled by the controller so as not to be displayed is changed to a set value that is different from a set value registered for the authenticated operator, the controller performs control so as to display the setting item with the changed set value.

### BRIEF DESCRIPTION OF THE DRAWINGS

An exemplary embodiment of the present invention will be described in detail based on the following figures, wherein:

FIG. 1 is a block diagram illustrating the hardware configuration of an image forming apparatus 10 according to an exemplary embodiment of the present invention;

FIG. 2 is a block diagram illustrating the functional configuration of the image forming apparatus 10 according to the exemplary embodiment of the present invention;

FIG. 3 illustrates an example of customization information stored in a customization information storage section 26;

FIG. 4 illustrates an example of a menu screen displayed on an operation panel 34;

FIG. 5 illustrates an example of a copy screen (initial screen) displayed on the operation panel 34;

FIG. 6 illustrates an example of an authentication screen displayed on the operation panel 34;

FIG. 7 illustrates an example of the copy screen displayed on the operation panel 34;

FIG. 8 illustrates an example of the copy screen displayed on the operation panel 34;

FIG. 9 illustrates operation of setting items for the image forming apparatus 10 according to the exemplary embodiment of the present invention;

FIGS. 10A to 10C illustrate an example of operation of the image forming apparatus 10 according to the exemplary embodiment of the present invention;

FIG. 11 illustrates another display example of operation of the image forming apparatus 10 according to the exemplary embodiment of the present invention;

FIG. 12 illustrates another display example of operation of the image forming apparatus 10 according to the exemplary embodiment of the present invention;

FIG. 13 illustrates another display example of operation of the image forming apparatus 10 according to the exemplary embodiment of the present invention;

FIG. 14 illustrates another display example of operation of the image forming apparatus 10 according to the exemplary embodiment of the present invention; and

FIG. 15 illustrates another display example of operation of the image forming apparatus 10 according to the exemplary embodiment of the present invention.

### DETAILED DESCRIPTION

Now, an exemplary embodiment of the present invention will be described in detail below with reference to the drawings.

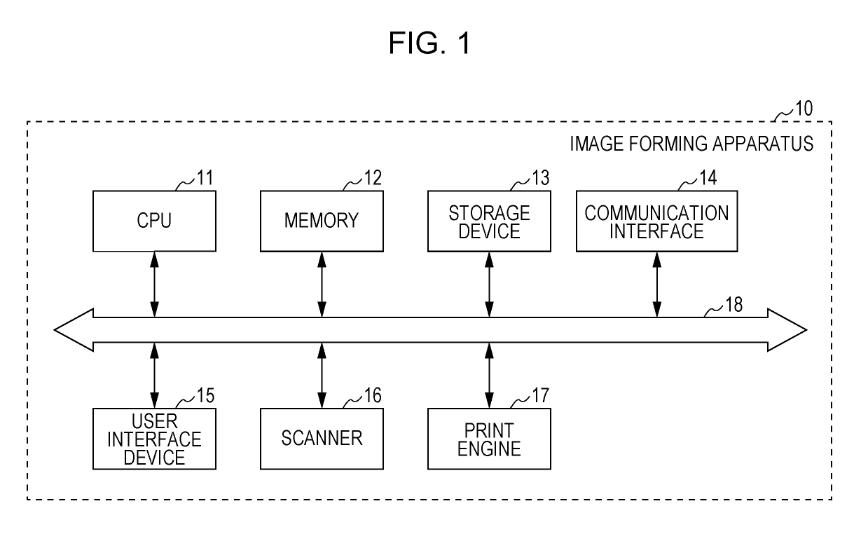

FIG. 1 illustrates the hardware configuration of an image forming apparatus 10 which is an example of an information processing apparatus according to the exemplary embodiment.

As illustrated in FIG. 1, the image forming apparatus 10 includes a central processing unit (CPU) 11, a memory 12, a storage device 13 such as a hard disk drive (HDD), a communication interface 14 that transmits and receives data to and from an external device or the like via a network, a user interface device 15 that includes a touch panel or a liquid crystal display and a keyboard, a scanner 16, and a print engine 17. Such components are connected to each other via a control bus 18.

The print engine 17 prints an image on a recording medium such as printing paper through processes such as charging, exposure, development, transfer, and fixation.

The CPU 11 controls operation of the image forming apparatus 10 by executing a predetermined process on the basis of a control program stored in the memory 12 or the storage device 13. In the exemplary embodiment, the CPU 11 reads and executes a control program stored in the memory 12 or the storage device 13. However, such a program may be stored in a storage medium such as a CD-ROM to be provided to the CPU 11.

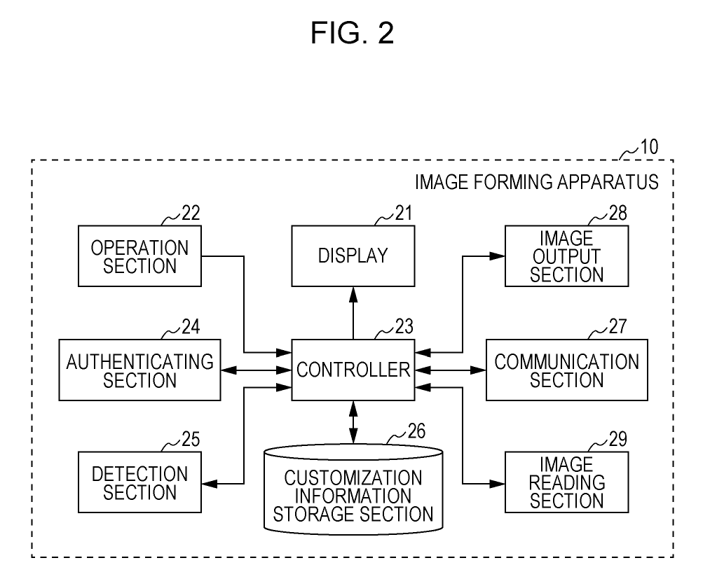

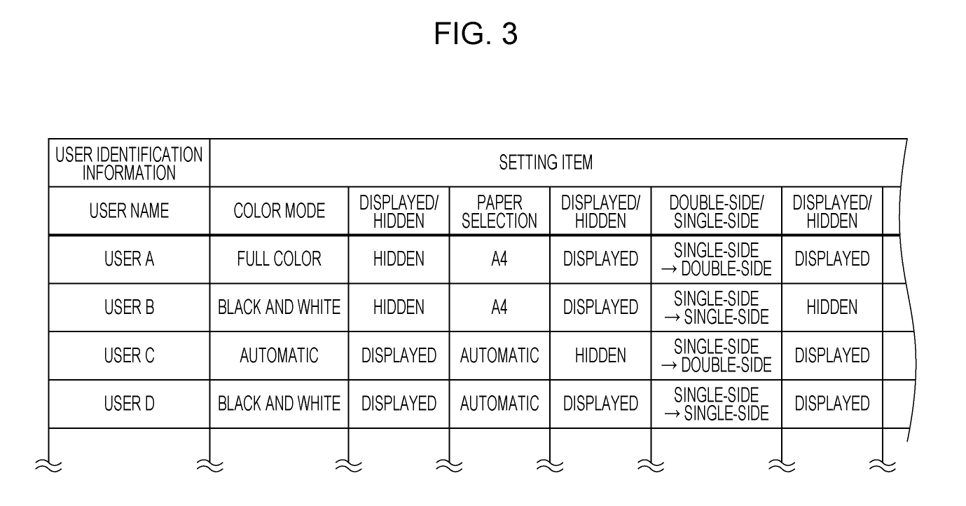

FIG. 2 is a block diagram illustrating the functional configuration of the image forming apparatus 10 which is implemented by executing the control program described above. FIG. 3 illustrates an example of customization information stored in a customization information storage section 26.

As illustrated in FIG. 2, the image forming apparatus 10 according to the exemplary embodiment includes a display 21, an operation section 22, a controller 23, an authenticating section 24, a detection section 25, the customization information storage section 26, a communication section 27, an image output section 28, and an image reading section 29.

The image output section 28 executes a process of outputting an image onto a recording medium such as printing paper. The image reading section 29 executes a process of reading a document image by scanning a document.

The controller 23 performs various types of control, such as controlling operation of the image output section 28 and the image reading section 29 and displaying and hiding various types of information on and from the display 21, on the basis of operation information input using the operation section 22.

In FIG. 2, the display 21 and the operation section 22 are illustrated as separate components. In the exemplary embodiment, however, the display 21 and the operation section 22 are constituted as an integral component by a touch screen.

The authenticating section 24 authenticates a user that attempts to use the image forming apparatus 10 using an authentication method such as input of an ID and a password and an IC card, for example.

The customization information storage section 26 stores, as customization information, set values registered in advance by the user for setting items related to plural functions of the image forming apparatus 10. Specifically, as illustrated in FIG. 3, the customization information storage section 26 stores, as customization information, set values registered in advance by the user for setting items such as the color mode, paper selection, double-side/single-side selection, magnification selection, and concentration adjustment and information as to whether to display or hide the setting items.

The detection section 25 detects whether or not the set value for a setting item which has been registered to be hidden in advance by the user, in the customization information which is stored in the customization information storage section 26, has been changed to a set value different from the registered set value because of the device state of a multi-function device, the authority state, or the like. The term “device state” refers to the mechanical state of the apparatus. Examples of a change in set value due to the device state include a case where the set value for the color mode registered to be hidden in advance by the user is “full color” and the set value is changed to “black and white” because of the depletion of a color toner. The term “authority state” refers to a state in which an administrator imposes or cancels a restriction on a change in set value by an operator. Examples of a change in set value due to the authority state include a case where there is a restriction on the number of copies to be made (e.g. full-color copies may be made up to a maximum of 99 copies; 100 or more copies may be made in black and white) and the number of copies to be made has become equal to or more than 100 and the set value for the color mode is changed to “black and white” although the set value for the color mode which has been registered to be hidden in advance by the user is “full color”.

The controller 23 controls the display 21 so as to display and hide the setting items on the basis of the customization information which is stored in the customization information storage section 26. In the case where the detection section 25 has detected that the set value for a setting item which has been registered to be hidden in advance by the user has been changed to a set value different from the registered set value, the controller 23 performs control so as to display the setting item which has been registered to be hidden.

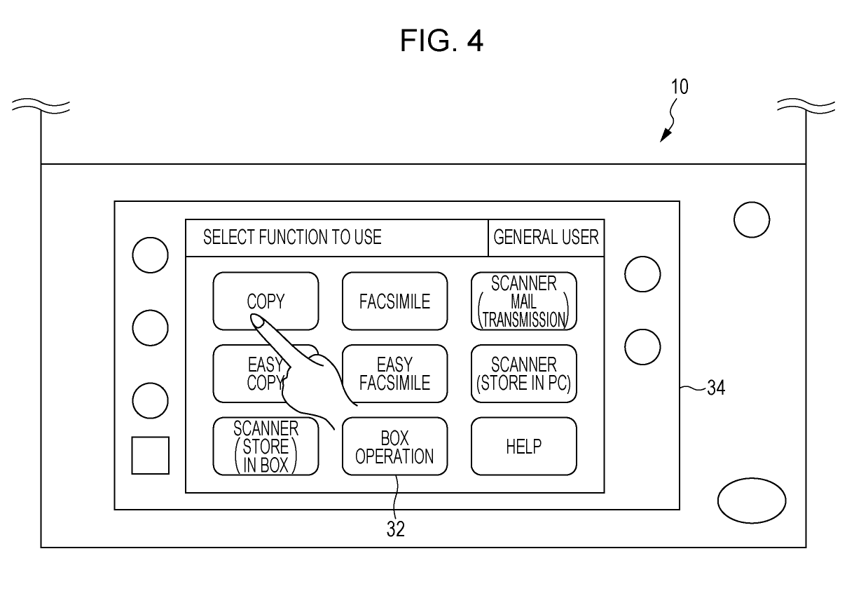

As illustrated in FIG. 4, the display 21 displays, on an operation panel 34, a menu screen that includes plural icons 32 that are pictorial figures corresponding to the plural functions on the basis of the control by the controller 23. When the icon 32 such as “copy”, “facsimile”, “scanner”, , “box operation”, and “help” illustrated in FIG. 4 is operated by touching the icon 32 using an operating element such as a finger or a pen, the display 21 transitions to a screen for making a change to the setting of the various functions.

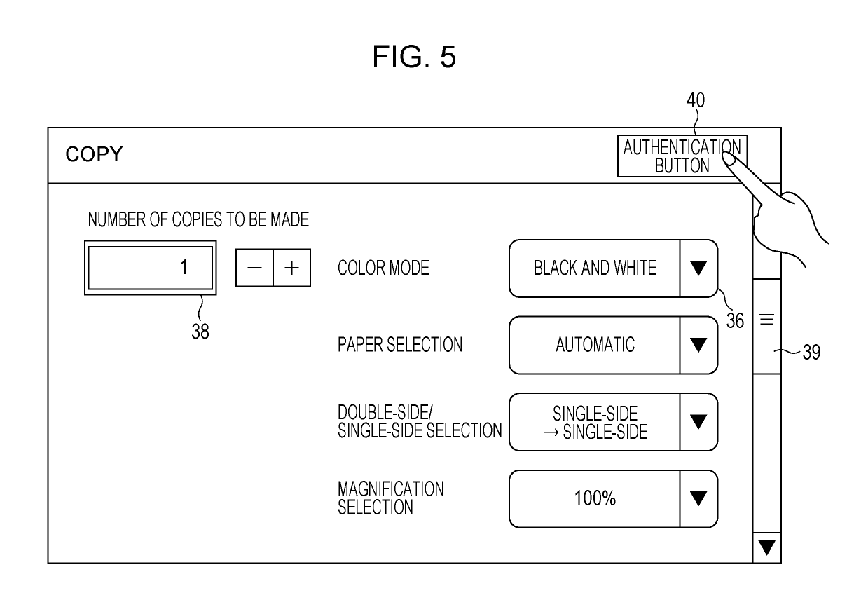

The display 21 displays a copy screen that includes plural icons 36 for providing information related to the plural functions related to copying, such as that illustrated in FIG. 5, in the case where the “copy” icon 32 is selected on the menu screen.

The “icons” are pictorial figures displayed on a display screen for starting a specific application program or indicating an operation position for transitioning to a specific screen. The pictorial figures include not only designed figures but also various types of characters such as alphabets and hiragana, katakana, and kanji characters.

On the copy screen illustrated in FIG. 5, a numeral is input to a double rectangular box 38 corresponding to “number of copies to be made”, for example, and the right portion of each of the plural icons 36 is touched using the operating element to select a set value for a setting item related to the corresponding function. In addition, when a scroll bar 39 is touched using the operating element and moved vertically, plural setting items are displayed to allow selection of set values for the plural setting items being displayed.

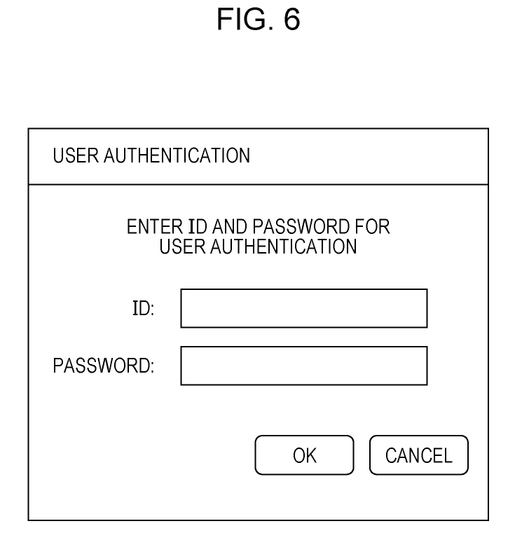

In the exemplary embodiment, an authentication screen such as that illustrated in FIG. 6, for example, is displayed when an authentication button 40 displayed on the copy screen is touched.

A message that prompts the user to input an ID and a password is displayed on the authentication screen. When an ID and a password are input and the authenticating section 24 performs an authentication process, the detection section 25 detects whether or not there is any set value for a setting item that has been registered to be hidden in advance by the user and that has been changed to a set value different from the registered set value because of the device state of the multi-function device, the authority state, or the like.

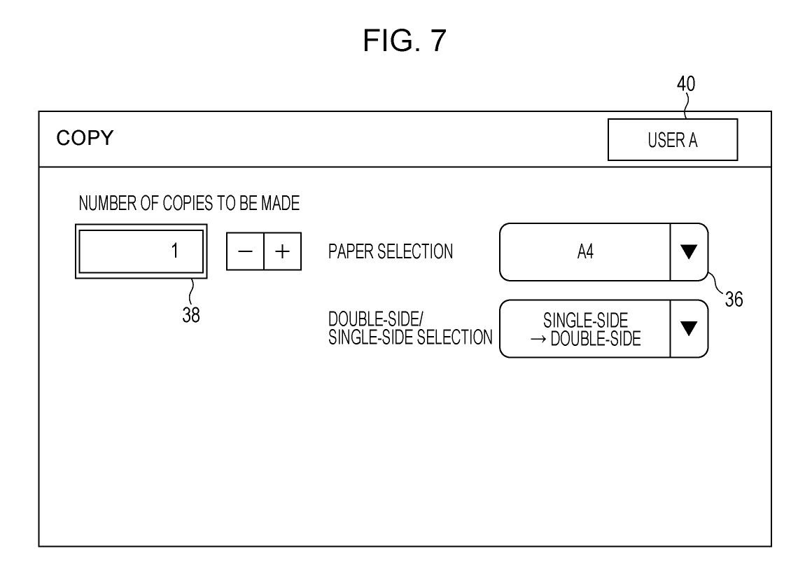

In the case where the detection section 25 detects that there is no set value that has been changed, the set values for the setting items are changed from the initial values to the set values which have been stored in the customization information storage section 26 and registered in advance by the authenticated user, and the setting items which have been registered to be displayed are displayed on the copy screen which is authenticated by the user. Specifically, as illustrated in FIG. 7, the set values for the setting items are changed to the set values which have been registered in advance by a user A that has been authenticated, and the setting items which have been registered to be displayed are displayed on the copy screen, with “paper selection” and “double-side/single-side selection” changed to “A4” and “single side→double side”, respectively. A change is made to the values for the setting items which have been registered to be hidden, e.g. “color mode” which is changed to “full color”, but such items are not displayed on the copy screen.

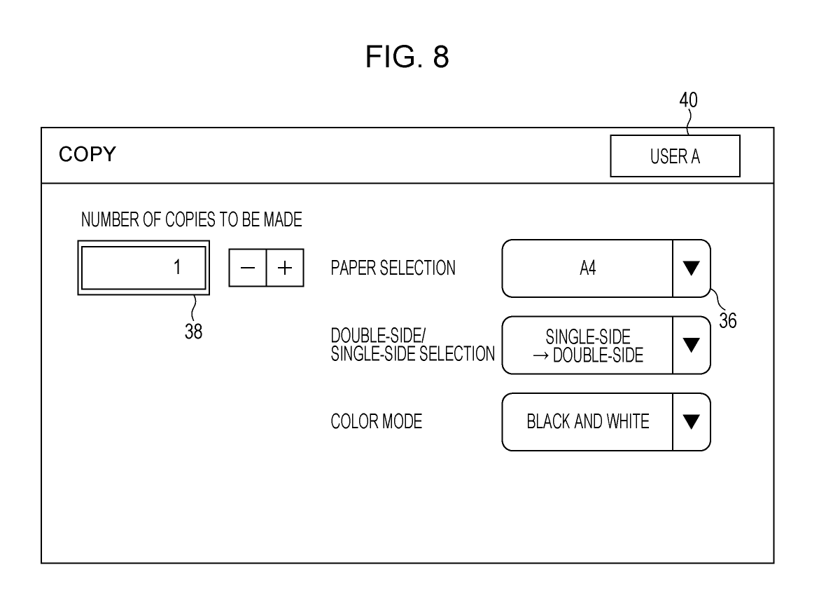

In the case where the detection section 25 detects that there is any set value that has been changed, meanwhile, the set values for the setting items are changed from the initial values to the set values which have been stored in the customization information storage section 26 and registered in advance by the authenticated user, and the setting items which have been registered to be displayed and the setting item with the changed set value which is detected by the detection section 25 are displayed on the copy screen which is authenticated by the user. Specifically, as illustrated in FIG. 8, the set values for the setting items are changed to the set values which have been registered in advance by the user A who has been authenticated, the setting items which have been registered to be displayed are displayed, with “paper selection” and “double-side/single-side selection” changed to “A4” and “single side→double side”, respectively, and the setting item which has been registered to be hidden and with the changed set value is displayed, with “color mode” changed (from “full color” to “black and white”).

In the case where the user has not been authenticated through an authentication process as described above, the controller 23 controls the display 21 so as to display set values saved as the initial values. In the case where the user has been authenticated through an authentication process, the controller 23 controls the display 21 so as to display set values registered to be displayed in advance by the authenticated user. In the case where the set values which have been registered to be not displayed (be hidden) in advance by the authenticated user are changed, the controller 23 controls the display 21 so as to display such set values.

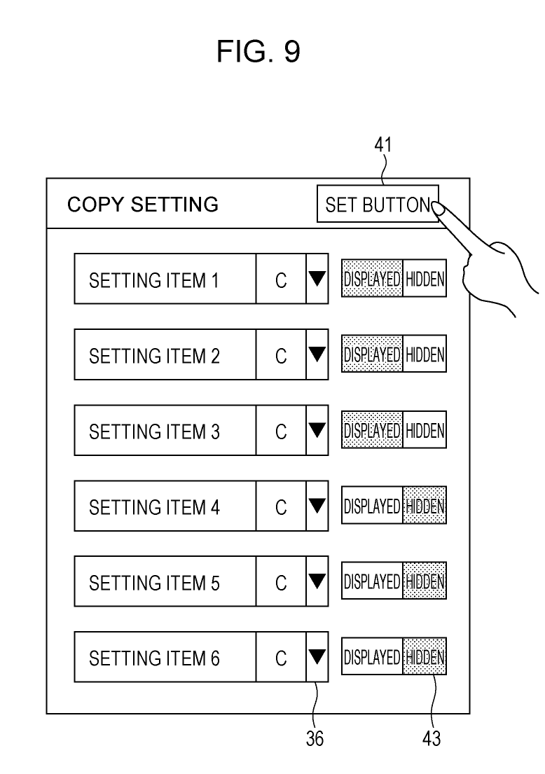

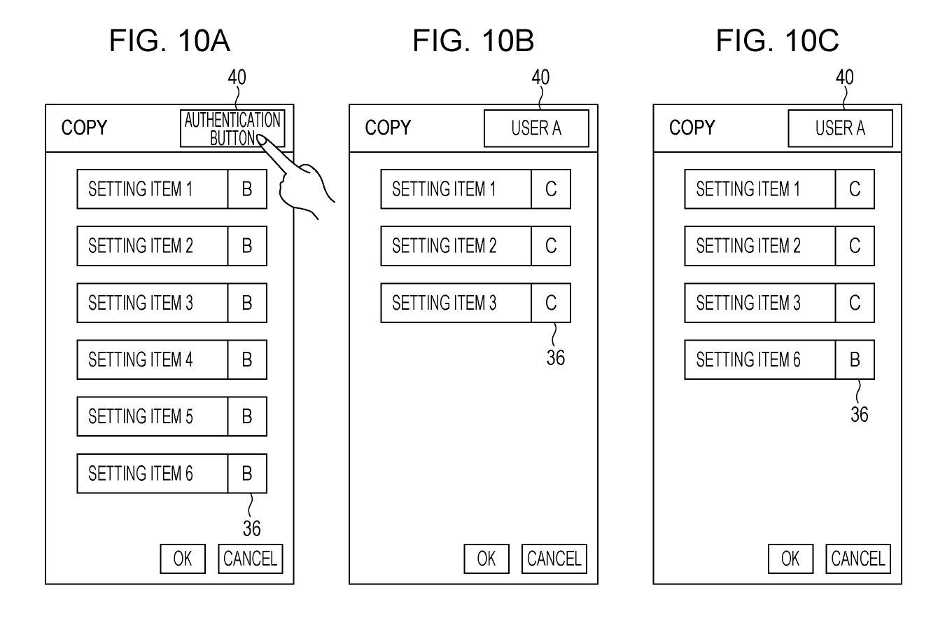

Next, operation of the image forming apparatus 10 according to the exemplary embodiment of the present invention will be described with reference to FIGS. 9 and 10. FIG. 9 illustrates operation of setting the setting items for the image forming apparatus 10. FIGS. 10A to 10C illustrate an example of operation of the image forming apparatus 10. Setting items 1 to 6 are setting items related to the functions of the image forming apparatus 10 such as “color mode”, “paper selection”, “magnification selection”, “concentration adjustment”, and “double-side/single-side selection”. Set values A, B, and C may be set for the setting items 1 to 6. The initial values for the setting items on an initial screen before authentication are all determined as “B”. The set values for the setting items which are stored in the customization information storage section 26 as the customization information on the user A are all determined as “C”.

First, on a copy setting screen in the state of the initial screen, the set values for the setting items 1 to 6 are selected by touching the right portion of the icons 36 using the operating element. In addition, one of “display” and “hide” buttons 43 is selected for the setting items 1 to 6. When a set button 41 is touched, the set values are registered for the setting items, and whether or not to display the setting items is registered (stored) as the customization information. Specifically, as illustrated in FIG. 9, “C” is selected as the set values for all the setting items 1 to 6, “display” is selected for the setting items 1 to 3, “hide” is selected for the setting items 4 to 6, and the set button 41 is touched using the operating element.

When the authentication button 40 is touched on the copy screen in the state of the initial screen as illustrated in FIG. 10A, a user authentication screen illustrated in FIG. 6 is displayed. When an ID and a password are input, the authenticating section 24 performs an authentication process.

The detection section 25 detects whether or not any of the set values for the setting items which have been registered has been changed from the set value which is registered to be hidden. In the case where the detection section 25 detects that none of the set values has been changed from the set value which is registered to be hidden, the set value which is the initial value is changed to the set value (customization information) corresponding to the authenticated user to be displayed. Specifically, when the authentication button 40 is touched on the initial screen as illustrated in FIG. 10A and the authenticating section 24 performs an authentication process, a change is made for the setting items 1 to 6 from “B” which is the initial value to “C” which is the set value for the user A who has been authenticated, the setting items 1 to 3 which have been registered to be displayed are displayed, and the setting items 4 to 6 which have been registered to be hidden are not displayed.

In the case where the detection section 25 detects that any of the set values has been changed from the set value which is registered to be hidden, the setting item with the set value changed from the set value which is registered to be hidden is displayed. Specifically, in the case where the set value for the setting item 6 which has been registered to be hidden is changed from “C” which is the set value registered for the user A to “B” as illustrated in FIG. 10C, the setting item 6 with the changed set value is displayed as being changed to the set value “B”.

When an OK button is touched, a process is executed using the set values which are set for the setting items.

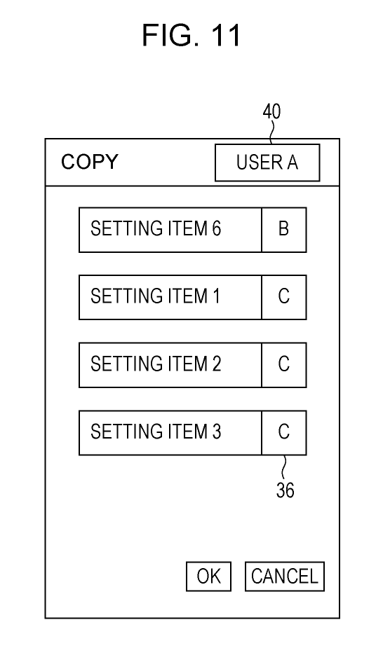

FIGS. 11 to 15 illustrate other display examples of operation of the image forming apparatus 10 according to the exemplary embodiment of the present invention.

In the case where the detection section 25 detects that any of the set values has been changed from the set value which is registered to be hidden, the setting item with the set value changed from the set value for the setting item which has been registered to be hidden may be displayed at an upper level than the other setting items. Specifically, as illustrated in FIG. 11, in the case where the set value for the setting item 6 which has been registered to be hidden is changed from “C” which is the set value registered for the user A to “B”, the setting item 6 with the changed set value may be displayed at an upper level than the other setting items 1, 2, and 3 to suggest that the set value for the setting item 6 has been changed to the set value “B”.

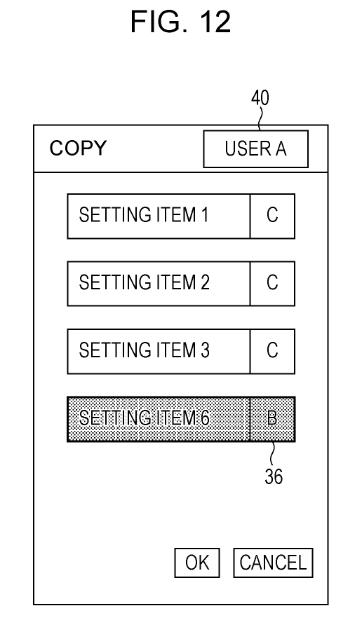

In the case where the detection section 25 detects that any of the set values has been changed from the set value which is registered to be hidden, the setting item with a set value changed from the set value for the setting item which has been registered to be hidden may be displayed differently, e.g. grayed out, from the other setting items. Specifically, in the case where the set value for the setting item 6 which has been registered to be hidden is changed from “C” which is the set value registered for the user A to “B” as illustrated in FIG. 12, the setting item 6 with the changed set value is displayed as grayed out to suggest that the set value for the setting item 6 has been changed to the set value “B”.

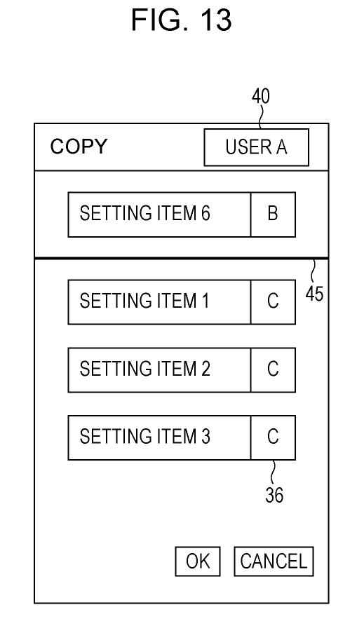

In the case where the detection section 25 detects that any of the set values has been changed from the set value which is registered to be hidden, the setting item with the set value changed from the set value for the setting item which has been registered to be hidden may be displayed separately with a delimiter from the other setting items. Specifically, as illustrated in FIG. 13, in the case where the set value for the setting item 6 which has been registered to be hidden is changed from “C” which is the set value registered for the user A to “B”, the setting item 6 with the changed set value may be displayed at an upper level than the other setting items 1, 2, and 3 and separately with a line 45 provided between the setting item 6 and the setting items 1 to 3 to suggest that the set value for the setting item 6 has been changed to the set value “B”.

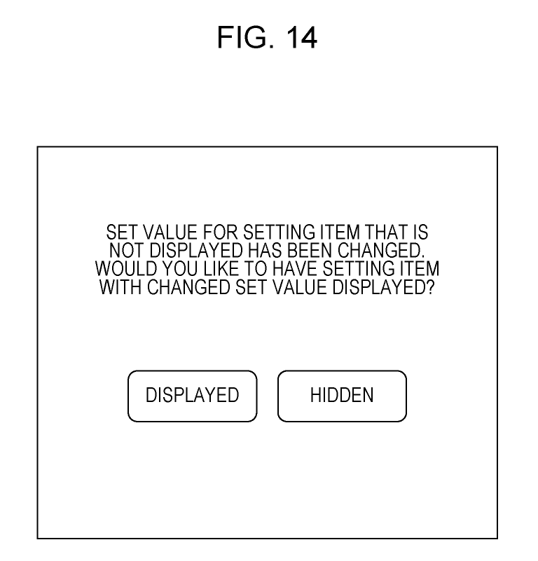

In the case where the detection section 25 detects that any of the set values has been changed from the set value which is registered to be hidden, a selection screen that indicates that the set value for a setting item that is not displayed has been changed and that allows the user to select whether or not to display the setting item with the changed set value may be displayed as illustrated in FIG. 14.

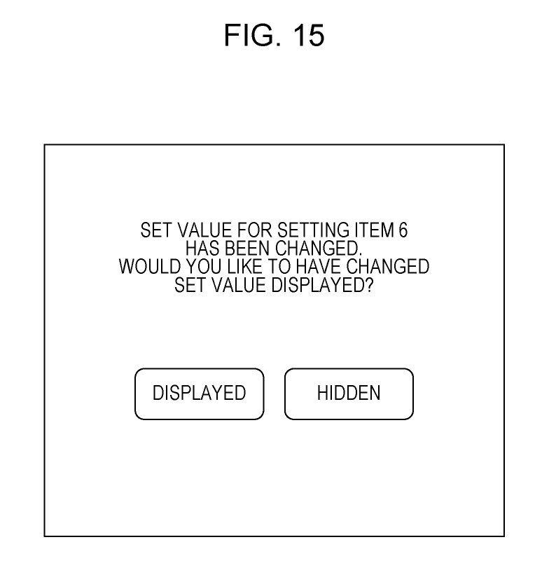

In the case where the detection section 25 detects that any of the set values has been changed from the set value which is registered to be hidden, a selection screen that indicates the setting item with the changed set value and that allows the user to select whether or not to display the changed set value may be displayed as illustrated in FIG. 15.

In the exemplary embodiment described above, one of the setting items which have been registered to be hidden has a changed set value. However, the present invention is not limited thereto, and may also be applied to a case where two or more of the setting items which have been registered to be hidden have a changed set value.

In the exemplary embodiment described above, the user is authenticated using an authentication method such as input of an ID and a password. However, the present invention is not limited thereto, and the user may be authenticated using an authentication method in which an IC card is used or the like.

In the exemplary embodiment described above, whether or not a set value has been changed is detected when an authentication process is performed. However, the present invention is not limited thereto, and may also be applied to a case where a set value is changed because of the mechanical state, the authority state, or the like during process execution.

### Modification

In the exemplary embodiment described above, the present invention is applied to an image forming apparatus. However, the present invention is not limited thereto. The present invention may also be applied to other information processing apparatuses such as a smartphone, a personal computer, and a tablet terminal apparatus alike.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing apparatus performing a function having a value set by a setting item unrelated to display of the setting item, comprising:
a processor configured to
authenticate an operator;
control the setting item not to be displayed for a set value registered to the authenticated operator, and
to display the previously undisplayed setting item in response to changing the set value for the apparatus function unrelated to setting-item display to a value different from the registered value.

2. The information processing apparatus according to claim 1,
in a case where the set value for the setting item which is controlled so as not to be displayed is changed to a set value that is different from the registered value, the processor is configured to display the setting item with the changed set value together with another setting item to be displayed for the operator.

3. The information processing apparatus according to claim 1,
in a case where the set value for the setting item which is controlled so as not to be displayed is changed to a set value that is different from the registered value, the processor is configured to display the setting item with the changed set value at a higher level than other displayed setting items or differently from the other displayed setting items.

4. The information processing apparatus according to claim 1,
in a case where the set value for the setting item which is controlled so as not to be displayed is changed to a set value that is different from the registered value, the processor is configured to display the setting item with the changed set value separately from other displayed setting items.

5. The information processing apparatus according to claim 1,
in a case where the set value for the setting item which is controlled so as not to be displayed is changed to a set value that is different from the registered value, the processor is configured to display a message indicating the existence of the changed set value.

6. An image forming apparatus performing a function having a value set by a setting item unrelated to display of the setting item, comprising:
a processor configured to
authenticate an operator, and
control the setting item not to be displayed for a set value registered to the authenticated operator, and
to display the previously undisplayed setting item in response to changing the set value for the apparatus function unrelated to setting-item display to a value different from the registered value; and
an image output unit that outputs an image onto a recording medium using set values for the plurality of setting items.

7. An information processing method performing a function having a value set by a setting item unrelated to display of the setting item, comprising:
authenticating an operator; and
controlling the setting item
not to be displayed for a set value registered to the authenticated operator, and
to display the previously undisplayed setting item in response to changing the set value for the apparatus function unrelated to setting-item display to a value different from the registered value.

8. A non-transitory computer readable medium storing a program causing a computer to execute a process as an information processing apparatus performing a function having a value set by a setting item unrelated to display of the setting item, comprising:
authenticating an operator; and
controlling the setting item
not to be displayed for a set value registered to the authenticated operator, and
to display the previously undisplayed setting item in response to changing the set value for the apparatus function unrelated to setting-item display to a value different from the registered value.

9. The information processing apparatus according to claim 5,
in a case where the set value for the setting item which is controlled so as not to be displayed is changed to a set value that is different from the registered set value, the processor is configured to display a selection screen that allows selection as to whether or not to display the setting item with the changed set value.
